(19) United States
(12) Patent Application Publication
(10) Pub. No.: US 2017/0352018 A1
(43) Pub. Date: Dec. 7, 2017

(54) System and Method for Processing Vouchers

(71) Applicant: Voucher Activation IP Services Pte. Ltd, Singapore (SG)

(72) Inventors: Philip Graham Cooper, Johannesburg (ZA); Jason Marc Schmulian, Glenhazel (ZA); Jonathan Paul Hunt, Peterborough, Cambridgeshire (GB); Vijay Raghunathan, Gurgaon, Haryana (IN); Dean Andrew Money, Lincoln, Lincolnshire (GB)

(21) Appl. No.: 15/534,969

(22) PCT Filed: Dec. 3, 2015
(86) PCT No.: PCT/IB2015/059324

§ 371 Date: Jun. 9, 2017

(30) Foreign Application Priority Data
Dec. 11, 2014 (IN) 1291/KOL/2014

(51) Int. Cl. G06Q 20/28

(52) U.S. Cl. CPC G06Q 20/28

(57) ABSTRACT

A voucher processor (122) receives (204) a plurality of voucher identifiers from a voucher provider (132) and, for each voucher identifier, instructs (208) the issuing of payment credentials of a payment instrument from an issuer processor (123). The issuer processor (123) or the voucher processor (122) links (210) each voucher identifier to payment credentials of a corresponding payment instrument. The voucher processor (122) or issuer processor (123) submits the plurality of voucher identifiers to the voucher provider (132) along with the linked payment credentials for each voucher identifier, such that, subsequent to a voucher being activated (408), the voucher provider is capable of initiating (424) a transfer of funds associated with the voucher in favour of the voucher provider (132) by transmitting the payment credentials linked to the voucher identifier for receipt by the issuer processor (123). The issuer processor (123) may receive the payment credentials via an acquiring bank (138) and a payment processor (124) in an open-loop manner.

### CROSS-REFERENCE TO RELATED APPLICATION

This application claims priority to Indian provisional patent application number 1291/KOL/2014 filed on 11 Dec. 2014, the content of which is incorporated by reference herein.

### FIELD OF THE INVENTION

This invention relates to a system and method for processing vouchers.

### BACKGROUND TO THE INVENTION

Both physical and digital vouchers are commonly issued by various entities. Closed loop networks, in which vouchers can only be redeemed at an issuing voucher provider, are often used to distribute, activate and process vouchers. For example, voucher providers such as Apple iTunes®, Google Play® and Starbucks® typically issue vouchers which can be purchased from channel partners, such as merchants or mobile network operators, and redeemed at the particular voucher provider. In the case of online content providers, vouchers are redeemable by accessing an online platform.

Typically, physical vouchers are manufactured and distributed to channel partners. Each voucher is provided with a unique voucher identifier which may, for example, be a code concealed by an opaque film which must be removed in order to reveal the code. The voucher is generally associated with a specific amount which only becomes redeemable at the voucher provider once the voucher is activated upon purchase.

In order to activate a voucher, a consumer may purchase the voucher from a channel partner which may, for example, be a participating merchant. The merchant transmits a voucher activation request to a voucher processor, typically via one or more switching platforms and/or processing networks. Once the voucher is activated and the consumer has provided payment, the voucher can be redeemed at the voucher provider. In closed loop models, switching platforms and integrator networks are responsible for routing activation requests and responses between the merchant and the voucher provider, and for facilitating the transfer of funds to the voucher provider according to predefined rules relating to fees and commissions. Industry examples of entities offering and managing activation and funding networks include inComm® and Blackhawk Network®.

Closed loop voucher processing models such as those implemented by online content providers have proven to be successful in certain markets. However, cross-border processing of vouchers in a closed loop model may be problematic as it involves cross-border integration of processing systems that may not easily integrate with each other, or may be difficult or unworkable to integrate while subject to processing and/or other commercial frameworks or regulations that may apply in certain territories. Moreover, settlement processes in closed loop models may lack the transaction security associated with conventional authorisation and settlement facilitated by payment processing networks provided by entities such as MasterCard® and Visa®.

Embodiments of the technology described herein aim to address these problems, at least to some extent.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

In accordance with a first aspect of the invention there is provided a computer-implemented method of processing a voucher conducted at a voucher processor comprising:
receiving a voucher identifier from a voucher provider, the voucher identifier associated with a voucher;
instructing the issuing of payment credentials of a payment instrument associated with an issuer processor, the payment credentials being linked to the voucher identifier; and
causing the payment credentials to be transmitted to the voucher provider with an indication that the payment credentials are linked to the voucher identifier;
such that, subsequent to the voucher being activated, the voucher provider is capable of initiating a transfer of funds associated with the voucher in favour of the voucher provider by transmitting the payment credentials linked to the voucher identifier for receipt by the issuer processor.

Further features provide for the method to include:
receiving a voucher activation request, the voucher activation request including the voucher identifier;
transmitting the voucher activation request to the voucher provider;
receiving a response from the voucher provider indicating that the voucher has been activated; and
transmitting a payment instrument activation instruction to the issuer processor, the payment instrument activation instruction indicating that the payment instrument is to be activated and loaded with an amount associated with the voucher.

Further features provide for the voucher activation request to be received from a channel partner, the channel partner receiving payment for the voucher from a consumer; for the voucher activation request to be received from a point-of-sale (POS) device of the channel partner via a switching platform; for the voucher activation request to be transmitted to the voucher provider via an integrator network, and the voucher activation request to include an amount associated with the voucher.

Yet further features provide for the payment instrument to be a payment card instrument; for the payment credentials to include a Primary Account Number (PAN), a card expiry date and a Card Verification Value (CVV); and for the payment card instrument to be a prepaid debit card instrument.

In one embodiment, instructing the issuing of payment credentials of the payment instrument associated with the issuer processor to include obtaining the payment credentials and linking the payment credentials to the voucher identifier.

In a different embodiment, instructing the issuing of payment credentials of the payment instrument associated with the issuer processor includes instructing the issuer processor to issue the payment credentials, the issuer processor linking the payment credentials to the voucher identifier. In this case, causing the payment credentials to be transmitted to the voucher provider may include instructing the issuer processor to transmit the payment credentials to the voucher provider.

Further features provide for transmitting the voucher activation request to the voucher provider to include transmitting a voucher activation instruction indicating that the voucher is to be activated and loaded with the amount associated with the voucher; and in response to receiving a response from the voucher provider indicating that the voucher has been activated and receiving a response from the issuer processor indicating that the payment instrument has been activated, designating the voucher as active, and transmitting, to the channel partner, a voucher activation confirmation such that the channel partner can complete the activation.

In one embodiment, the voucher identifier is linked to the payment credentials subsequent to the voucher activation request being received at the voucher processor, and the payment credentials are transmitted to the voucher provider subsequent to the voucher being activated.

Further features provide for the voucher provider to initiate a transfer of funds associated with the voucher in favour of the voucher provider by transmitting the payment credentials linked to the voucher identifier to an acquiring bank associated with the voucher provider for onward transmission to the issuer processor via a payment processor.

A still further feature provides for the voucher provider and the channel partner to be located in different countries or regions, wherein the countries or regions may be subject to different regulatory or technical requirements or frameworks.

The invention extends to a system for processing a voucher, comprising a voucher processor in communication with a voucher provider, the voucher processor including:
a voucher receipt component configured to receive a voucher identifier from a voucher provider, the voucher identifier associated with a voucher;
a payment credential component configured to instruct the issuing of payment credentials of a payment instrument associated with an issuer processor,
a linking component configured to cause the linking of the payment credentials to the voucher identifier; and
a transmitting component configured to cause the payment credentials to be transmitted to the voucher provider with an indication that the payment credentials are linked to the voucher identifier;
such that, subsequent to the voucher being activated, the voucher provider is capable of initiating a transfer of funds associated with the voucher in favour of the voucher provider by transmitting the payment credentials linked to the voucher identifier for receipt by the issuer processor.

The system may further include a voucher activation component having:
an activation receipt module configured to receive a voucher activation request from a channel partner, the voucher activation request including the voucher identifier;
an activation transmission module configured to transmit the voucher activation request to the voucher provider;
a response module configured to receive a response from the voucher provider indicating that the voucher has been activated;
an activating module configured to designate the voucher as active and transmit a voucher activation confirmation to the channel partner such that the channel partner can complete the activation; and
a payment instrument module configured to transmit a payment instrument activation instruction to the issuer processor, the payment instrument activation instruction indicating that the payment instrument is to be activated and loaded with an amount associated with the voucher.

The invention further extends to a computer-implemented method of processing a voucher conducted at a voucher provider comprising:
creating a voucher identifier associated with a voucher;
transmitting the voucher identifier to a voucher processor, the voucher processor instructing the issuing of payment credentials of a payment instrument associated with an issuer processor, the payment credentials being linked to the voucher identifier;
receiving the payment credentials together with an indication that the payment credentials are linked to the voucher identifier; and
subsequent to the voucher being activated, initiating a transfer of funds associated with the voucher in favour of the voucher provider by transmitting the payment credentials linked to the voucher identifier for receipt by the issuer processor.

Further features provide for the method to include:
receiving a voucher activation request from the voucher processor, the voucher activation request including the voucher identifier;
activating the voucher; and
sending a response to the voucher processor that the voucher is activated, the voucher processor transmitting a payment instrument activating instruction to the issuer processor indicating that the payment instrument is to be activated and loaded with an amount associated with the voucher.

Still further features provide for initiating the transfer of funds to include providing the payment credentials to an acquiring bank associated with the voucher provider for onward transmission to the issuer processor via a payment processor, for the transfer of funds to be fulfilled by way of a transfer from an issuing sponsor bank to the acquiring bank via the payment processing network, and for the transfer of funds to form part of a batch settlement process carried out by the payment processing network.

Yet further features provide for the method to include:
receiving the voucher identifier from a consumer;
checking whether the voucher has been activated; and,
in response to determining that the voucher has been activated, permitting redemption of the voucher.

The invention further extends to a system for processing vouchers, comprising a voucher provider in communication with a voucher processor, the voucher provider including:
a voucher creating component configured to create a voucher identifier associated with a voucher;
a voucher transmitting component configured to transmit the voucher identifier to a voucher processor, the voucher processor instructing the issuing of payment credentials of a payment instrument associated with an issuer processor, the payment credentials being linked to the voucher identifier;
a receiving component configured to receive the payment credentials together with an indication that the payment credentials are linked to the voucher identifier;
a database configured to store the voucher identifier and linked payment credentials; and
a funds transfer component configured to, subsequent to the voucher being activated, initiating a transfer of funds associated with the voucher in favour of the voucher provider by transmitting the payment credentials linked to the voucher identifier for receipt by the issuer processor.

Further features provide for the voucher provider to include a voucher activation component having:
an activation receipt module configured to receive a voucher activation request from the voucher processor, the voucher activating request including the voucher identifier;
an activation module configured to activate the voucher; and
a response module configured to send a response to the voucher processor that the voucher is activated, the voucher processor transmitting a payment instrument activating instruction to the issuer processor indicating that the payment instrument is to be activated and loaded with an amount associated with the voucher.

In order for the invention to be more fully understood, implementations thereof will now be described with reference to the accompanying drawings.

### BRIEF DESCRIPTION OF THE DRAWINGS

The invention will now be described, by way of example only, with reference to the accompanying representations in which:

FIG. 1 is a schematic illustration of an embodiment of a system wherein vouchers issued by a voucher provider are configured prior to being distributed to channel partners;

FIG. 2 is a swim-lane flow diagram illustrating exemplary steps conducted in order to configure vouchers, using the system of FIG. 1;

FIG. 3 is a schematic illustration of an embodiment of a voucher processing system;

FIG. 4 is a swim-lane flow diagram illustrating an exemplary voucher processing method, using the system of FIG. 3;

FIG. 5A is a block diagram illustrating components of an embodiment of a voucher processor;

FIG. 5B is a block diagram illustrating components of an embodiment of a voucher provider; and

FIG. 6 is a block diagram illustrating an example of the architecture of a processor in which various aspects of the disclosure may be implemented.

### DETAILED DESCRIPTION WITH REFERENCE TO THE DRAWINGS

Embodiments disclosed herein provide a system and method for processing a voucher. In some embodiments, a voucher processor receives a plurality of voucher identifiers from a voucher provider. The voucher processor may, for each voucher identifier, instruct the issuing of payment credentials of a payment instrument from an issuer processor and the issuer processor or the voucher processor may link each voucher identifier to payment credentials of a corresponding payment instrument. The voucher processor or issuer processor may submit the plurality of voucher identifiers to the voucher provider along with the linked payment credentials for each voucher identifier, such that, subsequent to a voucher being activated, the voucher provider is capable of initiating a transfer of funds associated with the voucher in favour of the voucher provider by transmitting the payment credentials linked to the voucher identifier for receipt by the issuer processor. The issuer processor may receive the payment credentials via an acquiring bank and a payment processor in an open-loop manner.

In this way, vouchers may be activated and redeemed using a closed loop system, while the voucher provider ultimately obtains payment for the voucher via a payment processor which may form part of an open loop transaction authorisation and settlement system. These and other technical advantages will become more apparent from what follows.

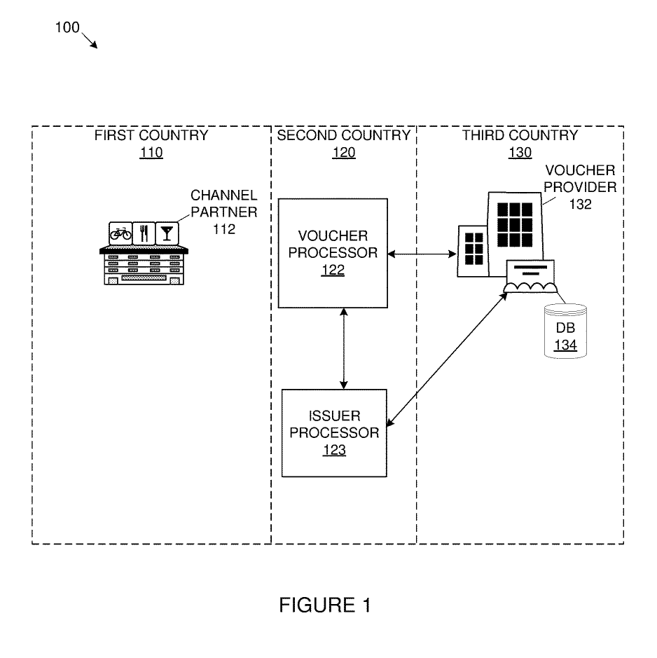

A system (100) including a channel partner (112), a voucher processor (122), an issuer processor (123), and a voucher provider (132) is shown in FIG. 1. In this embodiment, the channel partner (112) is a participating merchant located in a first country (110), the voucher processor (122) is located in a second country (120), and the voucher provider (132) is located in a third country (130), while the issuer processor (123) forms part of a payment processing network operating across a number of countries.

Throughout this specification, exemplary embodiments are described wherein the voucher provider (132) and the channel partner (112) are located in different countries or regions which may be subject to different regulatory or technical requirements or frameworks. It should be appreciated that these exemplary embodiments are non-limiting in nature and are primarily provided for exemplary purposes. Thus, in other embodiments, one or more of the channel partner (112), the voucher processor (122), the issuer processor (123) and the voucher provider (132) may be located in or may operate in the same country or region or in any number of different countries or regions.

The channel partner (112) may be any suitable entity such as a participating merchant, a mobile network operator, a bank or a corporate entity from which a consumer may purchase a digital or physical voucher. The voucher provider (132) may be any suitable entity issuing and/or distributing vouchers and at which such vouchers may typically be redeemed. In the exemplary embodiments described herein, the voucher provider (132) is an online content provider issuing physical vouchers which can be purchased at the channel partner (112) and redeemed via an online platform. Examples of online content providers include Apple iTunes® and Google Play®. The voucher provider (132) has an associated database (134) for storing payment credentials with linked voucher identifiers. The system (100) may include a plurality of voucher providers and a plurality of channel partners, as will be well understood by those of ordinary skill in the art.

The voucher processor (122) may be any entity responsible for one or more of requesting, distributing, routing, activating and processing of vouchers and/or facilitating payments associated with vouchers on behalf of the voucher provider (132). The voucher processor (122) may include multiple server computers and subsystems and may be located at a single location or distributed across multiple locations. In some embodiments, the voucher processor (122) may have components in different regions or countries. The voucher processor (122) is capable of communicating with the channel partner (112), the issuer processor (123) and the voucher provider (132), and such communication may occur over any suitable wired or wireless network, including the Internet.

The issuer processor (123) is capable of communicating with the voucher processor (122) and voucher provider (132) and may use any suitable wired or wireless network, including the Internet. The issuer processor (123) may form part of a payment processing network. Alternatively, the issuer processor (123) may be independent and not associated with a payment processor that routes transactions between issuing and acquiring banks, as will be described in greater detail below.

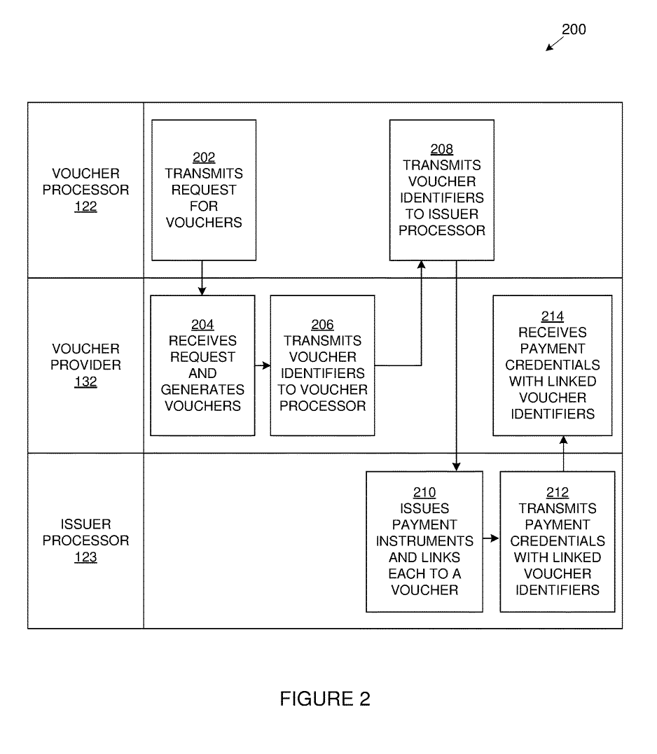

In embodiments disclosed in this description, prior to vouchers being distributed to the channel partner (112), a number of steps are conducted in order to configure the vouchers. Exemplary steps are shown in the swim-lane flow diagram (200) of FIG. 2, which indicates actions and responsibilities of the voucher processor (122), voucher provider (132) and the issuer processor (123), respectively.

The voucher processor (122) transmits (202) a request for a list of new vouchers to the voucher provider (132). The voucher provider (132) receives (204) the request and generates or obtains the vouchers. Each voucher has a voucher identifier which may, for example, be a unique code which can identify a particular voucher. In one specific example, the voucher identifier may be a code printed on a physical voucher concealed by an opaque film which must be removed in order to reveal the code. It should be appreciated that any suitable voucher identifier may be used, and that the voucher identifier may in certain cases not be visible or known to the consumer and/or the channel partner (112).

The voucher provider (132) then transmits (206) a list of the voucher identifiers to the voucher processor (122). The voucher processor (122), in turn, transmits (208) these voucher identifiers to the issuer processor (123) with an instruction to link each voucher identifier to payment credentials of a payment instrument. In this embodiment, the voucher processor (122) thus instructs the issuing of payment credentials of a payment instrument for each voucher.

The issuer processor (123) proceeds to issue (210) payment instruments and links payment credentials of each payment instrument to a voucher identifier of a voucher. The payment instrument is associated with the issuer processor (123), which means that the issuer processor (123) is capable of authorising a transaction initiated using the payment credentials of the payment instrument. In some embodiments, the payment instrument may be a payment card, a proxy payment card or a token associated with such a card, and the payment credentials may include a Primary Account Number (PAN), a card expiry date and a Card Verification Value (CVV for Visa®) or Card Verification Code (CVC for MasterCard®), or any suitable payment credentials required for conducting a transaction to be processed by the issuer processor (123). In the exemplary implementations described herein, the payment card is a prepaid debit card instrument which is activated by the issuer processor (123) and which is loaded with value corresponding to an amount associated with the voucher it is linked to. It will be appreciated that the prepaid debit card instrument is not in the form of a physical plastic card but that the term “prepaid debit card instrument” refers to the set of payment credentials issued in accordance with specifications for prepaid debit cards.

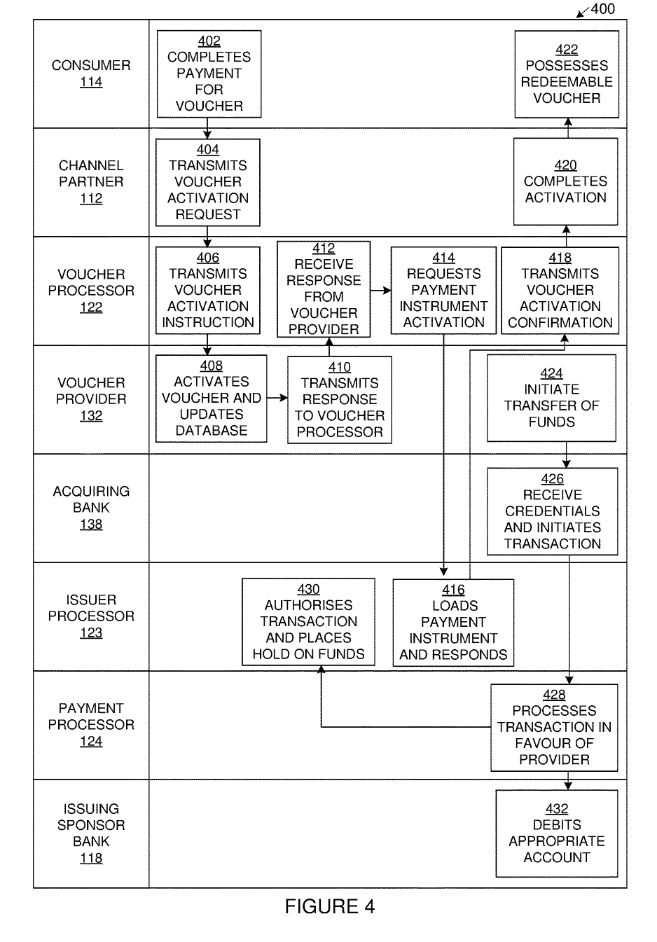

The payment credentials are linked to an issuing sponsor bank. The issuer processor may therefore be provided with information to enable it to identify the issuing sponsor bank involved. For example, in the case where a card is issued which has a PAN, the PAN must be issued with the appropriate Bank Identification Number (BIN) such that a subsequent transaction can be routed from the acquiring bank of the voucher provider to the issuing sponsor bank. In some cases, therefore, the issuing sponsor bank may act as the issuing bank of the linked payment credentials. Typically, the channel partner (112) provides payment for purchased vouchers to the issuing sponsor bank such that the funds may be transferred to the voucher provider (132). These aspects are described with reference to FIG. 4.

In other embodiments, the voucher processor (122), instead of instructing the issuer processor (123) to do so, may itself link the payment credentials to a voucher identifier of a voucher. In such cases, the voucher processor (122) may instruct the issuer processor (123) to issue the payment credentials, obtain the payment credentials from the issuer processor (123), and, after receiving the required payment credentials, link each set of payment credentials to a voucher identifier.

Turning again to the example of FIG. 2 and block 210, for each voucher, the issuer processor (123) then transmits (212) payment credentials to the voucher provider (132) with an indication that the payment credentials are linked to the voucher identifier. For example, the issuer processor (123) may transmit a file to the voucher provider (132) including a list of voucher identifiers with corresponding payment credentials. The linking and transmitting of the linked payment credentials is caused by the instruction to issue payment credentials received from the voucher processor (122). In other embodiments, for example, where the voucher processor (122) is responsible for linking the payment credentials to the voucher identifiers as described above, the voucher processor (122) may send the payment credentials to the voucher provider (132). The voucher provider (132) receives (214) the payment credentials with linked voucher identifiers and may store the necessary data in the database (134).

Whether the payment credentials are received from the issuer processor (123) or from the voucher processor (122), each voucher becomes linked to payment credentials of a payment instrument, such as a prepaid debit card instrument, such that the voucher provider (132) is capable of initiating a transfer of funds associated with the voucher in favour of the voucher provider (132) by transmitting the payment credentials linked to the voucher identifier for receipt by the issuer processor (123). This aspect will be described in greater detail in what follows.

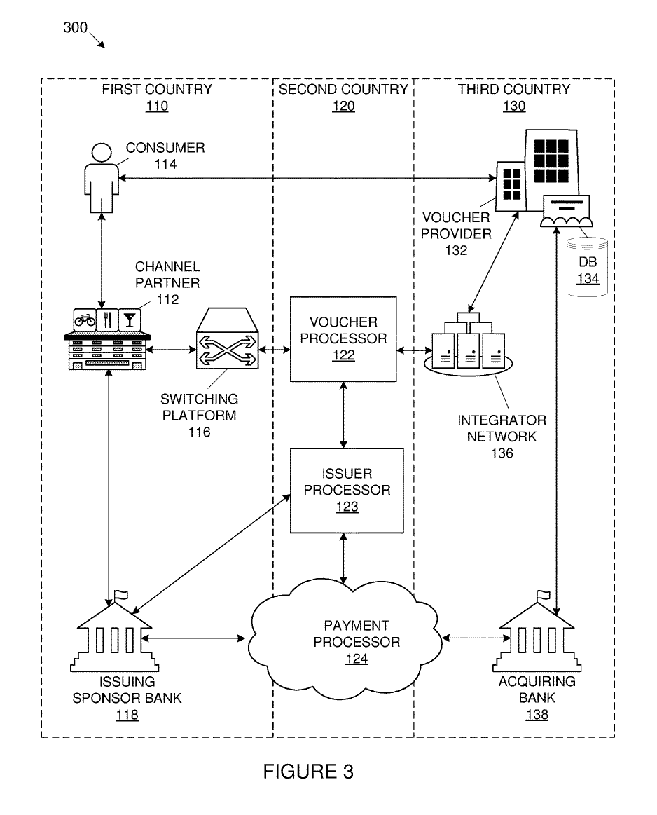

In the example of FIG. 2, voucher configuration thus involves linking each new voucher obtained by the voucher processor (122) with payment credentials of a payment instrument. Each voucher identifier may be linked to the payment credentials as part of a batch prior to voucher activation. In some cases, the voucher processor (122) may receive a voucher activation request before causing the voucher identifier and linked payment credentials to be transmitted to the voucher provider (132). The voucher identifier may then be linked to the payment credentials only subsequent to a voucher activation request being received at the voucher processor (122). The voucher processor (122) or issuer processor (123) may transmit the payment credentials to the voucher provider (132) subsequent to the voucher being activated, or even subsequent to the voucher being redeemed. These aspects will be described in greater detail with reference to FIGS. 3 and 4.

The voucher provider (132) is provided with the required information at some stage to enable it to store, in the database (134), the payment credentials in association with its corresponding voucher identifier for authorisation and settlement purposes. Once the above steps have been completed, the vouchers may be issued and/or distributed to the channel partner (112).

In order for a voucher to become redeemable, the voucher must be activated after it has been paid for by a consumer. FIG. 3 shows a system (300) including the channel partner (112), the voucher processor (122), the issuer processor (123), and the voucher provider (132) of FIG. 1, as well as a consumer (114), a switching platform (116), a payment processor (124) and an integrator network (136). Like numerals in FIGS. 1 and 3 refer to the same entities and components. The system (300) further includes an issuing sponsor bank (118) and an acquiring bank (138) associated with the voucher provider (132). In this embodiment, the consumer (114), channel partner (112), switching platform (116) and issuing sponsor bank (118) are situated in the first country (110), the voucher processor (122) is located in the second country (120), and the voucher provider (132), integrator network (136) and acquiring bank (138) are located in the third country (130).

The system (300) of FIG. 3 enables a voucher to be activated in closed loop manner, while the voucher provider (132) can obtain payment for purchased vouchers via an open loop payment processing network in a payment process facilitated by the payment processor (124).

In the embodiment of FIG. 3, voucher activation requests are received by the voucher processor (122) from the channel partner (112), the channel partner (112) having received payment for the voucher from the consumer (114). The voucher activation request is received via the switching platform (116), typically originating from a point-of-sale (POS) device of the channel partner (112). Exemplary switching platforms include EasyPay™ (based in South Africa) and Pine Labs™ (based in India). The voucher activation request may be transmitted from the voucher processor (122) to the voucher provider (132) via the integrator network (136). Exemplary integrator networks (136) include inComm® and Blackhawk Network®, and the functioning of such switching platforms and networks will be well understood by those of ordinary skill in the art.

It should be appreciated that the functionality of the switching platform, voucher processor and/or integrator network may be performed by the same entity. For example, in some embodiments, the voucher processor may also act as the integrator network communicating with the voucher provider and/or may also act as a switching platform responsible for routing requests from channel partners to appropriate destinations. In some embodiments, the switching platform and the integrator network may be operated by the same entity.

The issuer processor (123) and payment processor (124) may form part of a payment processing network provided by entities such as MasterCard® or Visa®. The payment processing network may include data processing subsystems, networks, and operations used to support and deliver authorization services, clearing and settlement services, and the like. For example, the payment processing network may comprise a server computer or cluster of server computers, coupled to a network interface (e.g. by an external communication interface), and a database(s) of information. Exemplary payment processors may include Banknet™ and VisaNet™, while exemplary issuer processors may include MasterCard Integrated Processing Solutions™ (IPS) and Visa Integrated Payments (VIP) system, which issue payment credentials, process authorization requests and which perform clearing and settlement services.

It should be appreciated that the functions of the issuer processor (123) and payment processor (124) may be performed by a single entity or by different entities, and that they may be operated from the same location or from different locations. For example, the issuer processor may be a so-called issuing third party processor (TPP) not owned or operated by a payment processing network, while the payment processor is an open loop payment processing network capable of communicating with the TPP.

The issuing sponsor bank (118) receives funds associated with purchased vouchers. These funds can be transferred to the acquiring bank (138) of the voucher provider (132) via the payment processor (124). Typically, such funds may be transferred in a conventional fashion via a payment processing network provided by entities such as MasterCard® or Visa®.

An exemplary voucher processing method, using the system (300) of FIG. 3, is shown in the swim-lane flow diagram (400) of FIG. 4. The consumer (114) pays (402) for a voucher at the channel partner (112). For example, the first country (110) may be India, the second country (120) may be Singapore, and the third country (130) may be the United States of America, and the consumer (114) may purchase an Apple iTunes® voucher to the amount of INR500 at a Croma™ store in India. The channel partner (112), in this example Croma™, transmits (404) a voucher activation request to the voucher processor (122) in Singapore. The voucher activation request includes at least the voucher identifier and may also include the applicable amount if the voucher is not associated with a fixed or pre-set amount.

The voucher processor (122) receives the voucher activation request and transmits (406) it, together with the amount if applicable, to the voucher provider (132). In this embodiment, the voucher activation request transmitted to the voucher provider (132) includes a voucher activation instruction indicating that the voucher is to be activated and loaded with the amount associated with the voucher.

The voucher provider (132) receives the voucher activation request from the voucher processor (122), activates (408) the voucher, and updates the database (134) to indicate that the voucher associated with the voucher identifier has been activated. The voucher provider (132) then transmits (410) a response indicating that the voucher has been activated. The voucher processor (122) then receives (412) the response indicating that the voucher has been activated by the voucher provider (132)

The voucher processor (122) requests (414) a payment instrument activation from the issuer processor (123), indicating that the payment instrument is to be activated and loaded with the amount associated with the voucher. In some embodiments, payment credentials may have already been linked to the voucher identifier as described above. In such a case, the issuer processor (123) activates the applicable payment instrument, for example the prepaid debit card instrument associated with the voucher identifier, and loads the amount to the payment instrument. In this example, INR500 is loaded to a prepaid debit card instrument. In other embodiments, the voucher identifier may not yet be linked to payment credentials. In such a case, the issuer processor (123) or the voucher processor (122) may proceed to first link the voucher identifier received from the channel partner (112) to the payment credentials as described with reference to FIGS. 1 and 2.

Whatever the case may be, the issuer processor (123) then loads (416) the amount to the payment instrument associated with the voucher identifier and responds to the voucher processor (122) indicating that the payment instrument has been activated. In response to receiving the response from the voucher provider (132) indicating that the voucher has been activated and receiving the response from the issuer processor (123) indicating that the payment instrument has been activated, the voucher is designated as active by the voucher processor (122). The voucher processor (122), then transmits (418) a voucher activation confirmation to the channel partner (112) such that the channel partner is capable of completing (420) the activation. The channel partner (112) may, for example, be a merchant that provides the consumer (114) with a transaction receipt and a voucher activation receipt after scanning a physical voucher and accepting payment. At that stage (422), the consumer (114) is in possession of a redeemable voucher.

In cases where the voucher provider (132) is an online content provider, the consumer (114) may access an online platform and enter a voucher code to redeem the voucher. The voucher provider (132) may then receive the voucher identifier, check whether the voucher has been activated, and, in response to determining that the voucher has been activated, permit redemption of the voucher based on the amount associated with the voucher.

At any time after the voucher has been activated, the voucher provider (132), in order to obtain payment from the channel partner (112), initiates (424) a transfer of funds, in this embodiment, using a conventional payment processing network infrastructure. In this example, initiating the transfer of funds includes providing the payment credentials associated with a certain voucher for which payment is sought to the acquiring bank (138) associated with the voucher provider (132) for onward transmission to the payment processor (124). The acquiring bank (138) receives (426) the payment credentials, which may include a PAN, expiry date and CVV or CVC, or may simply be a payment token, and provides it to the payment processor (124), which may, for example, be a payment processing network provided by MasterCard® or Visa®.

The payment processor (124) processes (428) the transaction in favour of the voucher provider (132). The payment processor (124) interacts with the issuer processor (123) which typically checks the payment credentials, authorises (430) the transaction and places a hold on the funds. The transfer of funds is fulfilled by way of a transfer from the issuing sponsor bank (118) to the acquiring bank via the payment processing network. In other words, an account into which funds were transferred from the channel partner (112) to the issuing sponsor bank (118) is debited (432) in favour of an account of the voucher provider (132) held at the acquiring bank (138), at a final stage (432). The account may, for example, be a trust account or a float account of the voucher processor (122).

It should be appreciated that the authorisation step (430) above may represent the final process for the authorisation, after which a clearing and settlement process may commence. For example, a clearing and settlement file may be transmitted from the acquiring bank via the payment processor to the issuing bank, which then performs settlement to the acquiring bank.

While the settlement process is described above with reference to a single voucher, it should be understood that the transfer of funds described above will typically form part of a batch settlement process carried out by a payment processing network. In some embodiments, the voucher provider (132) may periodically send a transaction report to the voucher processor (122). The voucher processor (122) may then send the transaction report to the merchant (112). The issuing sponsor bank (118) may pull funds from the channel partner (112) after a debit order instruction is sent to the issuing sponsor bank (118). The issuing sponsor bank (118) may pull funds from the channel partner (112) on a daily or periodic basis for all applicable transactions, or the channel partner (112) may deposit funds into an account held at the issuing sponsor bank (118) daily or periodically.

Where the issuer processor (123) includes payment processing systems such as MasterCard Integrated Processing Solutions™ (IPS), the transfer of funds may follow a predefined authorisation process. For example, the voucher provider (132) may transmit the payment credentials to the acquiring bank (138), which passes it on to the payment processor (124). The payment processor (124) may provide the payment credentials and other details to the issuer processor system such as IPS to authorise the transaction and place a hold on the funds. The payment processor (124) may send a successful authorisation message to the acquiring bank (138), which may in turn notify the voucher provider (132).

The above authorisations may be performed on a batch of transactions, and the acquiring bank (138) may periodically transmit a settlement file to the payment processor (124). A clearing message may be transmitted to the issuer processor (123) and the held balance may be permanently debited. The issuer processor (124) may transmit a report to the issuing sponsor bank (118) to perform reconciliation. The issuing sponsor bank (118) may then perform reconciliation and settlement. In cases where the issuing sponsor bank (118) and acquiring bank (138) are located in different currency regions, the acquiring bank (138) may convert the funds to the currency of its region and make the funds available to the voucher provider (132).

In the embodiments described herein, and contrastingly to typical closed loop voucher models wherein nett settlement processes are followed, the system (300) may employ a full settlement technique. In other words, the issuing sponsor bank (118) pays the full amount associated with the voucher to the acquiring bank (138) (subject to any applicable bank and processing fees). It should be appreciated that any suitable commissions or fees may be charged by the entities described after payment of the full amount to the voucher provider (132). For example, the voucher processor (122) may invoice the voucher provider (132) for an agreed amount or at a certain rate, while the voucher processor (122) may, in turn, make payments to one or more of the merchant (112), the switching platform (116), and the integrator network (136).

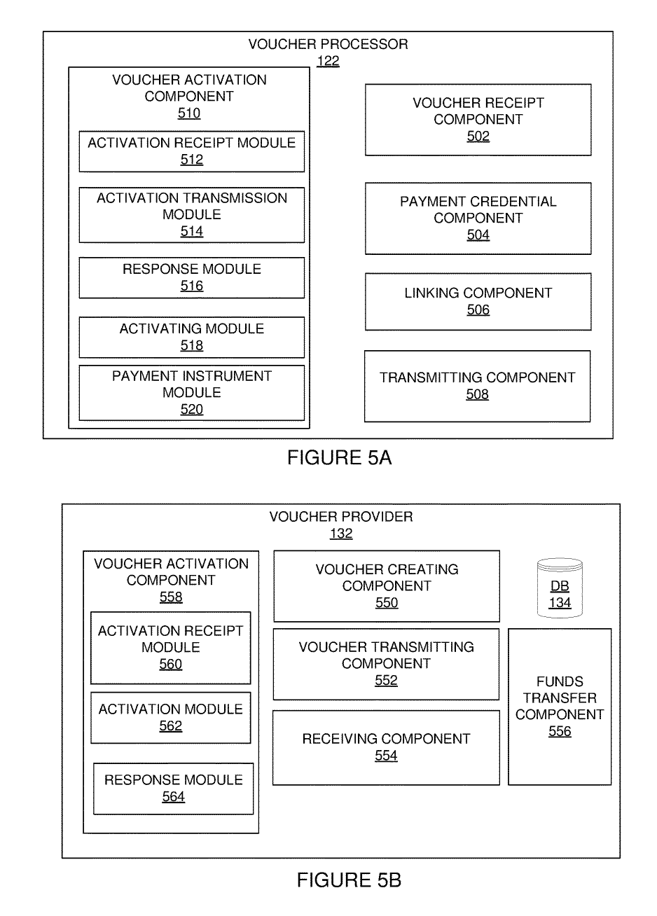

Components of the voucher processor (122) are illustrated in FIG. 5A. The voucher processor (122) may be in the form of at least one processor, a hardware module, or a circuit for executing the functions of the described components and modules which may be software units executing on the at least one processor, hardware module, or circuit. Multiple processors running parallel processing threads may be provided enabling parallel processing for some or all of the functions of the components and modules. Memory may be configured to provide computer instructions to the at least one processor to carry out the functionality of the components and modules. The voucher processor (122) may include one or more of: a voucher receipt component (502), a payment credential component (504), a linking component (506), a transmitting component (508) and a voucher activation component (510). The voucher activation component (510) may include an activation receipt module (512), activation transmission module (514), response module (516), activating module (518) and payment instrument module (520).

The voucher receipt component (502) may be configured to receive a voucher identifier from the voucher provider (132), and the payment credential component (504) may be configured to instruct the issuing of payment credentials of a payment instrument associated with the issuer processor (123), as described above. The linking component (506) may be configured to cause the linking of the payment credentials to the voucher identifier, and the transmitting component (508) may be configured to cause the payment credentials to be transmitted to the voucher provider with an indication that the payment credentials are linked to the voucher identifier.

The activation receipt module (512) of the voucher activation component (510) may be configured to receive a voucher activation request from the channel partner (112), the voucher activation request including the voucher identifier, and the activation transmission module (514) may be configured to transmit the voucher activation request to the voucher provider (132). The response module (516) may be configured to receive a response from the voucher provider (132) indicating that the voucher has been activated. The activating module (518) may be configured to designate the voucher as active and transmit a voucher activation confirmation to the channel partner (112) such that the channel partner (112) is capable of completing the activation. The payment instrument module (520) may be configured to transmit a payment instrument activation instruction to the issuer processor (123), the payment instrument activation instruction indicating that the payment instrument is to be activated and loaded with an amount associated with the voucher.

Components of the voucher provider (132) are illustrated in FIG. 5B. The voucher provider (132) may be in the form of at least one processor, a hardware module, or a circuit for executing the functions of the described components and modules which may be software units executing on the at least one processor, hardware module, or circuit. Multiple processors running parallel processing threads may be provided enabling parallel processing for some or all of the functions of the components and modules. Memory may be configured to provide computer instructions to the at least one processor to carry out the functionality of the components and modules. The voucher provider (132) may include one of more of: a voucher creating component (550), a voucher transmitting component (552), a receiving component (554), the database (134), a funds transfer component (556) and a voucher activation component (558). The voucher activation component (558) may include an activation receipt module (560), an activation module (562) and a response module (564).

The voucher creating component (550) may be configured to create a voucher identifier associated with a voucher, and the voucher transmitting component (552) may be configured to transmit the voucher identifier to the voucher processor (122), the voucher processor (122) instructing the issuing of payment credentials of a payment instrument associated with the issuer processor (123), the payment credentials being linked to the voucher identifier. The actual voucher itself may, of course, also be created by the voucher provider (132) or may be created by a third party under instruction from the voucher provider (132). The receiving component (554) may be configured to receive the payment credentials together with an indication that the payment credentials are linked to the voucher identifier, and to then store the voucher identifier and linked payment credentials on the database (134).

The activation receipt module (560) of the voucher activation component (558) may be configured to receive a voucher activation request from the voucher processor (122), the voucher activation request including the voucher identifier, and the activation module (562) may be configured to activate the voucher. The response module (564) may be configured to send a response to the voucher processor that the voucher is activated, the voucher processor transmitting a payment instrument activating instruction to the issuer processor indicating that the payment instrument is to be activated and loaded with an amount associated with the voucher. The funds transfer component (556) may be configured to, subsequent to the voucher being activated, initiate a transfer of funds associated with the voucher in favour of the voucher provider (132) by transmitting the payment credentials linked to the voucher identifier for receipt by the issuer processor (123) by means of the payment processor (124) as has been described.

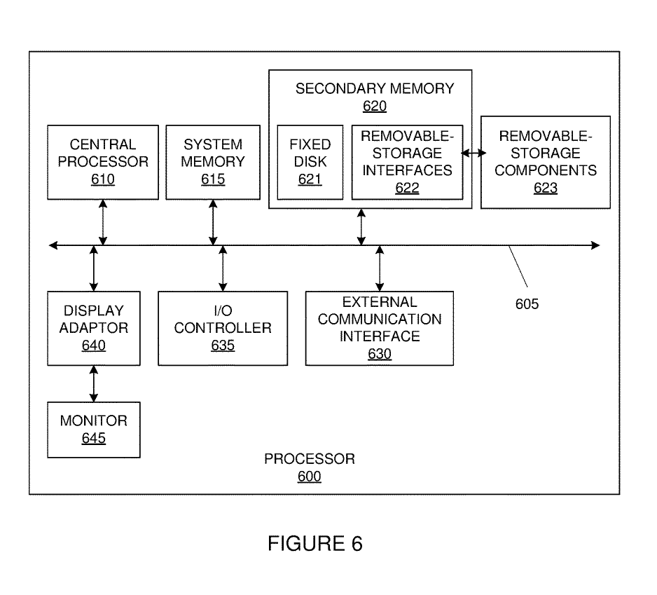

FIG. 6 illustrates an example of the architecture of a processor (600), such as is provided by the voucher processor (122) or voucher provider (132), in which various aspects of the disclosure may be implemented. The processor (600) may be suitable for storing and executing computer program code. The various participants and elements in the previously described system diagrams may use any suitable number of subsystems or components of the processor (600) to facilitate the functions described herein.

The processor (600) may include subsystems or components interconnected via a communication infrastructure (605) (for example, a communications bus, a cross-over bar device, or a network). The processor (600) may include at least one central processor (610) and at least one memory component in the form of computer-readable media. The memory components may include system memory (615), which may include read only memory (ROM) and random access memory (RAM). A basic input/output system (BIOS) may be stored in ROM. System software may be stored in the system memory (615) including operating system software. The memory components may also include secondary memory (620). The secondary memory (620) may include a fixed disk (621), such as a hard disk drive, and, optionally, one or more removable-storage interfaces (622) for removable-storage components (623).

The removable-storage interfaces (622) may be in the form of removable-storage drives (for example, magnetic tape drives, optical disk drives, etc.) for corresponding removable storage-components (for example, a magnetic tape or an optical disk, etc.), which may be written to and read by the removable-storage drive. The removable-storage interfaces (622) may also be in the form of ports or sockets for interfacing with other forms of removable-storage components (623) such as a flash memory drive, external hard drive, or removable memory chip, etc.

The processor (600) may include an external communications interface (630) for operation of the processor (600) in a networked environment enabling transfer of data between multiple processors (600). Data transferred via the external communications interface (630) may be in the form of signals, which may be electronic, electromagnetic, optical, radio, or other types of signal. The external communications interface (630) may enable communication of data between the processor (600) and other processors including servers and external storage facilities. Web services may be accessible by the processor (600) via the communications interface (630). The external communications interface (630) may also enable other forms of communication to and from the processor (600) including, voice communication, near field communication, Bluetooth™, etc.

The computer-readable media in the form of the various memory components may provide storage of computer-executable instructions, data structures, program modules, and other data. A computer program product may be provided by a computer-readable medium having stored computer-readable program code executable by the central processor (610). A computer program product may be provided by a non-transient computer-readable medium, or may be provided via a signal or other transient means via the communications interface (630). Interconnection via the communication infrastructure (605) allows a central processor (610) to communicate with each subsystem or component and to control the execution of instructions from the memory components, as well as the exchange of information between subsystems or components.

Peripherals and input/output (I/O) devices may couple to the processor (600) either directly or via an I/O controller (635). These components may be connected to the processor (600) by any number of means known in the art, such as a serial port.

The technology described herein provides a method and system for processing vouchers which may address problems associated with the implementation of closed loop voucher models, particularly in cases involving cross-border processing or transactions. In some embodiments, a plurality of vouchers may each be linked to a payment instrument and transmitted to a voucher provider prior to the vouchers becoming active. In other cases, linking can take place substantially in real-time, whereby linking is established during or shortly after voucher activation. In each of these cases, the voucher provider is at some stage, which may be before or after voucher activation, provided with a payment instrument by which to initiate open loop settlement by way of a payment processor.

It may be the case that cross-border processing of vouchers in a closed loop model may be problematic as it involves cross-border integration of processing systems that may not easily integrate with each other, or may be difficult or unworkable to integrate while subject to processing and/or other commercial frameworks or regulations that may apply in certain territories. Such frameworks or regulations may make, for example, nett settlement closed loop models difficult to implement or unworkable in some cases.

The technology described herein may provide numerous technical advantages. Embodiments disclosed combine closed loop activation processes with open loop authorisation and settlement. In this way, the settlement process follows existing credit or debit card process flows and may make use of existing authorisation and settlement infrastructure. This may make the repatriation of funds simpler, without the need to integrate cross-border platforms to a large extent. Use of existing processes may also reduce costs and provide for quicker authorisation and settlement.

Moreover, and particularly in cases where the issuer processor is responsible for linking the payment credentials to the voucher, the system and method described may provide enhanced transaction security. Payment processing networks such as Visa® and MasterCard® process transactions in accordance with standards such as the Payment Card Industry Data Security Standard (PCI DSS), which may provide greater security and a guarantees to the entities involved. Further, where the issuer processor performs linking of the payment credentials to the voucher identifiers and transmits the payment credentials to the voucher provider, it may not be necessary for the voucher processor to be exposed to payment card information. Therefore, the voucher processor may not be required to be PCI DSS compliant, which may reduce costs and regulatory burdens. Also, such payment processing networks may provide enhanced fraud detection capabilities.

In some embodiments, the voucher provider may be settled the full amount associated with a voucher, which may reduce regulatory burdens or tax complications on the voucher processor, switching platforms and/or integrator networks. A further advantage may be that the existing user experience and redemption process remains unaltered, as the purchase and redemption of a voucher remains the same from an individual consumer's perspective.

In some embodiments, the voucher may be a virtual or digital voucher. For example, the consumer may use a banking application or website to purchase a digital voucher which can be redeemed at a voucher provider. In such a case, the channel partner (e.g. bank) is provided with a plurality of voucher identifiers which can be provided to consumers upon purchase. The voucher processor may receive a voucher activation request for a particular voucher identifier from the channel partner. It may then transmit the request to the voucher provider with an indication that the request originates from a digital channel. The voucher provider may, substantially in real-time, activate the voucher for a particular amount. The voucher provider may then receive payment credentials and initiate payment for the voucher in a manner as described above.

It is envisaged that the technology herein described may be used to activate and load reloadable vouchers. For example, a consumer may have a static identifier, which may be stored on a mobile device, and which is associated with a reloadable voucher or a reloadable consumer account at a particular voucher provider. In an exemplary embodiment, the consumer may provide the static identifier to a channel partner, for example through a near-field communication (NFC) transfer between the mobile device storing the static identifier and a merchant POS, with a request to reload the voucher or account for a specific amount. In such a case, for every reload transaction initiated by the consumer, the voucher processor may request that payment credentials be issued by the issuer processor for the static identifier and that the corresponding payment instrument be loaded with the reload amount. The voucher processor or issuer processor may then link the static identifier of the consumer to the payment credentials such that the voucher provider can associate the consumer's reloadable voucher or reloadable account with the issued payment credentials.

Therefore, in some embodiments, a payment instrument such as a new prepaid debit card may be issued for each individual reload transaction on the same voucher or for the same account. These payment credentials may then be transmitted to the voucher provider and the voucher provider may obtain payment for the reload transactions in the same manner as described herein.

The foregoing description of embodiments has been presented for the purpose of illustration; it is not intended to be exhaustive or to limit the invention to the precise forms disclosed. Persons skilled in the relevant art can appreciate that many modifications and variations are possible in light of the above disclosure. The described operations may be embodied in software, firmware, hardware, or any combinations thereof. The software components or functions described in this application may be implemented as software code to be executed by one or more processors using any suitable computer language such as, for example, Java, C++, or Perl using, for example, conventional or object-oriented techniques. The software code may be stored as a series of instructions, or commands on a non-transitory computer-readable medium, such as a random access memory (RAM), a read-only memory (ROM), a magnetic medium such as a hard-drive, or an optical medium such as a CD-ROM. Any such computer-readable medium may also reside on or within a single computational apparatus, and may be present on or within different computational apparatuses within a system or network.

Any of the steps, operations, or processes described herein may be performed or implemented with one or more hardware or software modules, alone or in combination with other devices. In one embodiment, a software module is implemented with a computer program product comprising a non-transient computer-readable medium containing computer program code, which can be executed by a computer processor for performing any or all of the steps, operations, or processes described.

Throughout the specification and claims unless the contents requires otherwise the word ‘comprise’ or variations such as ‘comprises’ or ‘comprising’ will be understood to imply the inclusion of a stated integer or group of integers but not the exclusion of any other integer or group of integers.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention.

1. A computer-implemented method of processing a voucher conducted at a voucher processor comprising:
receiving a voucher identifier from a voucher provider, the voucher identifier associated with a voucher;
instructing the issuing of payment credentials of a payment instrument associated with an issuer processor, the payment credentials being linked to the voucher identifier; and
causing the payment credentials to be transmitted to the voucher provider with an indication that the payment credentials are linked to the voucher identifier;
such that, subsequent to the voucher being activated, the voucher provider is capable of initiating a transfer of funds associated with the voucher in favour of the voucher provider by transmitting the payment credentials linked to the voucher identifier for receipt by the issuer processor.

2. A method as claimed in claim 1, including:
receiving a voucher activation request, the voucher activation request including the voucher identifier;
transmitting the voucher activation request to the voucher provider;
receiving a response from the voucher provider indicating that the voucher has been activated; and
transmitting a payment instrument activation instruction to the issuer processor, the payment instrument activation instruction indicating that the payment instrument is to be activated and loaded with an amount associated with the voucher.

3. A method as claimed in claim 2, wherein the voucher activation request is received from a channel partner, the channel partner receiving payment for the voucher from a consumer.

4. (canceled)

5. A method as claimed claim 2, wherein the voucher activation request is transmitted to the voucher provider via an integrator network, and the voucher activation request includes an amount associated with the voucher.

6. A method as claimed in claim 1, wherein the payment instrument is a prepaid debit card instrument and the payment credentials include a Primary Account Number (PAN), a card expiry date and a Card Verification Value (CVV).

7. A method as claimed in claim 1, wherein instructing the issuing of payment credentials of the payment instrument associated with the issuer processor includes obtaining the payment credentials and linking the payment credentials to the voucher identifier.

8. A method as claimed in claim 1, wherein instructing the issuing of payment credentials of the payment instrument associated with the issuer processor includes instructing the issuer processor to issue the payment credentials, and for the issuer processor to link the payment credentials to the voucher identifier.

9. A method as claimed in claim 8, wherein causing the payment credentials to be transmitted to the voucher provider includes instructing the issuer processor to transmit the payment credentials to the voucher provider.

10. A method as claimed in claim 2, wherein transmitting the voucher activation request to the voucher provider includes transmitting a voucher activation instruction indicating that the voucher is to be activated and loaded with the amount associated with the voucher.

11. A method as claimed in claim 10 including: in response to receiving a response from the voucher provider indicating that the voucher has been activated and receiving a response from the issuer processor indicating that the payment instrument has been activated, designating the voucher as active, and transmitting, to a channel partner, a voucher activation confirmation such that the channel partner can complete the activation.

12. A method as claimed in claim 2, wherein the voucher identifier is linked to the payment credentials subsequent to the voucher activation request being received at the voucher processor, and wherein the payment credentials are transmitted to the voucher provider subsequent to the voucher being activated.

13. A method as claimed in claim 1, wherein the voucher provider initiates a transfer of funds associated with the voucher in favour of the voucher provider by transmitting the payment credentials linked to the voucher identifier to an acquiring bank associated with the voucher provider for onward transmission to the issuer processor via a payment processor.

14. (canceled)

15. A system for processing a voucher, comprising a voucher processor in communication with a voucher provider, the voucher processor including a processor and a memory configured to provide computer instructions to the processor to carry out the functionality of components including:
a voucher receipt component configured to receive a voucher identifier from a voucher provider, the voucher identifier associated with a voucher;
a payment credential component configured to instruct the issuing of payment credentials of a payment instrument associated with an issuer processor,
a linking component configured to cause the linking of the payment credentials to the voucher identifier; and
a transmitting component configured to cause the payment credentials to be transmitted to the voucher provider with an indication that the payment credentials are linked to the voucher identifier;
such that, subsequent to the voucher being activated, the voucher provider is capable of initiating a transfer of funds associated with the voucher in favour of the voucher provider by transmitting the payment credentials linked to the voucher identifier for receipt by the issuer processor.

16. A system as claimed in claim 15, wherein the voucher processor further includes a voucher activation component having:
an activation receipt module configured to receive a voucher activation request from a channel partner, the voucher activation request including the voucher identifier;
an activation transmission module configured to transmit the voucher activation request to the voucher provider;
a response module configured to receive a response from the voucher provider indicating that the voucher has been activated;
an activating module configured to designate the voucher as active and transmit a voucher activation confirmation to the channel partner such that the channel partner can complete the activation; and
a payment instrument module configured to transmit a payment instrument activation instruction to the issuer processor, the payment instrument activation instruction indicating that the payment instrument is to be activated and loaded with an amount associated with the voucher.

17. A computer-implemented method of processing a voucher conducted at a voucher provider comprising:
creating a voucher identifier associated with a voucher;
transmitting the voucher identifier to a voucher processor, the voucher processor instructing the issuing of payment credentials of a payment instrument associated with an issuer processor, the payment credentials being linked to the voucher identifier;
receiving the payment credentials together with an indication that the payment credentials are linked to the voucher identifier; and
subsequent to the voucher being activated, initiating a transfer of funds associated with the voucher in favour of the voucher provider by transmitting the payment credentials linked to the voucher identifier for receipt by the issuer processor.

18. A method as claimed in claim 17, including:
receiving a voucher activation request from the voucher processor, the voucher activation request including the voucher identifier;
activating the voucher; and
sending a response to the voucher processor that the voucher is activated, the voucher processor transmitting a payment instrument activating instruction to the issuer processor indicating that the payment instrument is to be activated and loaded with an amount associated with the voucher.

19. A method as claimed in claim 17, wherein initiating the transfer of funds includes providing the payment credentials to an acquiring bank associated with the voucher provider for onward transmission to the issuer processor via a payment processor, for the transfer of funds to be fulfilled by way of a transfer from an issuing sponsor bank to the acquiring bank via the payment processing network, and for the transfer of funds to form part of a batch settlement process carried out by the payment processing network.

20. A method as claimed in claim 17, including:
receiving the voucher identifier from a consumer;
checking whether the voucher has been activated; and,
in response to determining that the voucher has been activated, permitting redemption of the voucher.

21. A system for processing vouchers, comprising a voucher provider in communication with a voucher processor, the voucher provider including a processor and a memory configured to provide computer instructions to the processor to carry out the functionality of components including:
a voucher creating component configured to create a voucher identifier associated with a voucher;
a voucher transmitting component configured to transmit the voucher identifier to a voucher processor, the voucher processor instructing the issuing of payment credentials of a payment instrument associated with an issuer processor, the payment credentials being linked to the voucher identifier;
a receiving component configured to receive the payment credentials together with an indication that the payment credentials are linked to the voucher identifier;
a database configured to store the voucher identifier and linked payment credentials; and
a funds transfer component configured to, subsequent to the voucher being activated, initiating a transfer of funds associated with the voucher in favour of the voucher provider by transmitting the payment credentials linked to the voucher identifier for receipt by the issuer processor.

22. A system as claimed in claim 21, wherein the voucher provider further includes a voucher activation component having:
an activation receipt module configured to receive a voucher activation request from the voucher processor, the voucher activating request including the voucher identifier;
an activation module configured to activate the voucher; and
a response module configured to send a response to the voucher processor that the voucher is activated, the voucher processor transmitting a payment instrument activating instruction to the issuer processor indicating that the payment instrument is to be activated and loaded with an amount associated with the voucher.
